(19) United States
(12) Patent Application Publication
(10) Pub. No.: US 2025/0048156 A1
(43) Pub. Date: Feb. 6, 2025

(54) SOURCE LAYER 2 IDENTIFIER FOR PATH SWITCHING

(71) Applicant: QUALCOMM Incorporated, San Diego, CA (US)

(72) Inventors: Peng CHENG, Beijing (CN); Karthika PALADUGU, Hyderabad (IN); Hong CHENG, Basking Ridge, NJ (US)

(21) Appl. No.: 18/717,561

(22) PCT Filed: Feb. 1, 2022
(86) PCT No.: PCT/CN2022/075300

§ 371 Date: Jun. 7, 2024

(51) Int. Cl. H04W 24/10; H04W 76/11

(52) U.S. Cl. CPC H04W 24/10; H04W 76/11

(57) ABSTRACT

Various aspects of the present disclosure generally relate to wireless communication. In some aspects, a remote user equipment (UE) may generate a measurement report for discovery that includes a serving relay UE source Layer 2 (L2) identifier (ID), of a serving relay UE that serves the remote UE, and a candidate relay UE source L2 ID, for each candidate relay UE of a set of candidate relay UEs. The UE may transmit the measurement report. Numerous other aspects are described.

### FIELD OF THE DISCLOSURE

Aspects of the present disclosure generally relate to wireless communication and to techniques and apparatuses for providing a source Layer 2 identifier for path switching.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of switching from an indirect path to a direct path, in accordance with the present disclosure.

FIG. 5 is a diagram illustrating an example associated with providing source Layer 2 (L2) identifiers (IDs) for path switching, in accordance with the present disclosure.

FIG. 6 is a diagram illustrating an example of switching from a direct path to an indirect path, in accordance with the present disclosure.

FIG. 7 is a diagram illustrating an example associated with providing source L2 IDs for path switching, in accordance with the present disclosure.

FIG. 8 is a diagram illustrating an example process performed, for example, by a remote UE, in accordance with the present disclosure.

FIG. 9 is a diagram illustrating an example process performed, for example, by a network entity, in accordance with the present disclosure.

FIG. 10 is a diagram illustrating an example process performed, for example, by a remote UE, in accordance with the present disclosure.

FIG. 11 is a diagram illustrating an example process performed, for example, by a network entity, in accordance with the present disclosure.

FIGS. 12-13 are diagrams of example apparatuses for wireless communication, in accordance with the present disclosure.

### SUMMARY

Some aspects described herein relate to a method of wireless communication performed by a remote user equipment (UE). The method may include generating a measurement report for discovery that includes a serving relay UE source Layer 2 (L2) identifier (ID), of a serving relay UE that serves the remote UE, and a candidate relay UE source L2 ID, for each candidate relay UE of a set of candidate relay UEs. The method may include transmitting the measurement report.

Some aspects described herein relate to a method of wireless communication performed by a network entity. The method may include receiving a measurement report for discovery that includes a serving relay UE source L2 ID, of a serving relay UE that serves a remote UE, and a candidate relay UE source L2 ID, for each candidate relay UE for the remote UE. The method may include transmitting a reconfiguration message to switch the remote UE from an indirect path to a direct path based at least in part on the serving relay UE source L2 ID in consideration of the candidate relay source L2 ID for each candidate relay UE.

Some aspects described herein relate to a method of wireless communication performed by a remote UE. The method may include generating a message that includes a remote UE source L2 ID if the remote UE is in a connected state. The method may include transmitting the message.

Some aspects described herein relate to a method of wireless communication performed by a network entity. The method may include receiving, from a remote UE in a connected state, a sidelink UE information message that includes a remote UE source L2 ID for the remote UE. The method may include receiving, from a relay UE, a sidelink UE information message that includes the remote UE source L2 ID of the remote UE. The method may include transmitting, to the remote UE and the relay UE based at least in part on receiving the remote UE source L2 ID, a configuration message to switch the remote UE from a direct path to an indirect path via the relay UE.

Some aspects described herein relate to a remote UE for wireless communication. The remote UE may include a memory and one or more processors coupled to the memory. The one or more processors may be configured to generate a measurement report for discovery that includes a serving relay UE source L2 ID, of a serving relay UE that serves the remote UE, and a candidate relay UE source L2 ID, for each candidate relay UE of a set of candidate relay UEs. The one or more processors may be configured to transmit the measurement report.

Some aspects described herein relate to a network entity for wireless communication. The network entity may include a memory and one or more processors coupled to the memory. The one or more processors may be configured to receive a measurement report for discovery that includes a serving relay UE source L2 ID, of a serving relay UE that serves a remote UE, and a candidate relay UE source L2 ID, for each candidate relay UE for the remote UE. The one or more processors may be configured to transmit a reconfiguration message to switch the remote UE from an indirect path to a direct path based at least in part on the serving relay UE source L2 ID in consideration of the candidate relay source L2 ID for each candidate relay UE.

Some aspects described herein relate to a remote UE for wireless communication. The remote UE may include a memory and one or more processors coupled to the memory. The one or more processors may be configured to generate a message that includes a remote UE source L2 ID if the remote UE is in a connected state. The one or more processors may be configured to transmit the message.

Some aspects described herein relate to a network entity for wireless communication. The network entity may include a memory and one or more processors coupled to the memory. The one or more processors may be configured to receive, from a remote UE in a connected state, a sidelink UE information message that includes a remote UE source L2 ID for the remote UE. The one or more processors may be configured to receive, from a relay UE, a sidelink UE information message that includes the remote UE source L2 ID of the remote UE. The one or more processors may be configured to transmit, to the remote UE and the relay UE based at least in part on receiving the remote UE source L2 ID, a configuration message to switch the remote UE from a direct path to an indirect path via the relay UE.

Some aspects described herein relate to a non-transitory computer-readable medium that stores a set of instructions for wireless communication by a remote UE. The set of instructions, when executed by one or more processors of the remote UE, may cause the remote UE to generate a measurement report for discovery that includes a serving relay UE source L2 ID, of a serving relay UE that serves the remote UE, and a candidate relay UE source L2 ID, for each candidate relay UE of a set of candidate relay UEs. The set of instructions, when executed by one or more processors of the remote UE, may cause the remote UE to transmit the measurement report.

Some aspects described herein relate to a non-transitory computer-readable medium that stores a set of instructions for wireless communication by a network entity. The set of instructions, when executed by one or more processors of the network entity, may cause the network entity to receive a measurement report for discovery that includes a serving relay UE source L2 ID, of a serving relay UE that serves a remote UE, and a candidate relay UE source L2 ID, for each candidate relay UE for the remote UE. The set of instructions, when executed by one or more processors of the network entity, may cause the network entity to transmit a reconfiguration message to switch the remote UE from an indirect path to a direct path based at least in part on the serving relay UE source L2 ID in consideration of the candidate relay source L2 ID for each candidate relay UE.

Some aspects described herein relate to a non-transitory computer-readable medium that stores a set of instructions for wireless communication by a remote UE. The set of instructions, when executed by one or more processors of the remote UE, may cause the UE to generate a message that includes a remote UE source L2 ID if the remote UE is in a connected state. The set of instructions, when executed by one or more processors of the remote UE, may cause the remote UE to transmit the message.

Some aspects described herein relate to a non-transitory computer-readable medium that stores a set of instructions for wireless communication by a network entity. The set of instructions, when executed by one or more processors of the network entity, may cause the network entity to receive, from a remote UE in a connected state, a sidelink UE information message that includes a remote UE source L2 ID for the remote UE. The set of instructions, when executed by one or more processors of the network entity, may cause the network entity to receive, from a relay UE, a sidelink UE information message that includes the remote UE source L2 ID of the remote UE. The set of instructions, when executed by one or more processors of the network entity, may cause the network entity to transmit, to the remote UE and the relay UE based at least in part on receiving the remote UE source L2 ID, a configuration message to switch the remote UE from a direct path to an indirect path via the relay UE.

Some aspects described herein relate to an apparatus for wireless communication. The apparatus may include means for generating a measurement report for discovery that includes a serving relay UE source L2 ID, of a serving relay UE that serves the apparatus, and a candidate relay UE source L2 ID, for each candidate relay UE of a set of candidate relay UEs. The apparatus may include means for transmitting the measurement report.

Some aspects described herein relate to an apparatus for wireless communication. The apparatus may include means for receiving a measurement report for discovery that includes a serving relay UE source L2 ID, of a serving relay UE that serves a remote UE, and a candidate relay UE source L2 ID, for each candidate relay UE for the remote UE. The apparatus may include means for transmitting a reconfiguration message to switch the remote UE from an indirect path to a direct path based at least in part on the serving relay UE source L2 ID in consideration of the candidate relay source L2 ID for each candidate relay UE.

Some aspects described herein relate to an apparatus for wireless communication. The apparatus may include means for generating a message that includes a remote UE source L2 ID if the apparatus is in a connected state. The apparatus may include means for transmitting the message.

Some aspects described herein relate to an apparatus for wireless communication. The apparatus may include means for receiving, from a remote UE in a connected state, a sidelink UE information message that includes a remote UE source L2 ID for the remote UE. The apparatus may include means for receiving, from a relay UE, a sidelink UE information message that includes the remote UE source L2 ID of the remote UE. The apparatus may include means for transmitting, to the remote UE and the relay UE based at least in part on receiving the remote UE source L2 ID, a configuration message to switch the remote UE from a direct path to an indirect path via the relay UE.

Aspects generally include a method, apparatus, system, computer program product, non-transitory computer-readable medium, user equipment, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

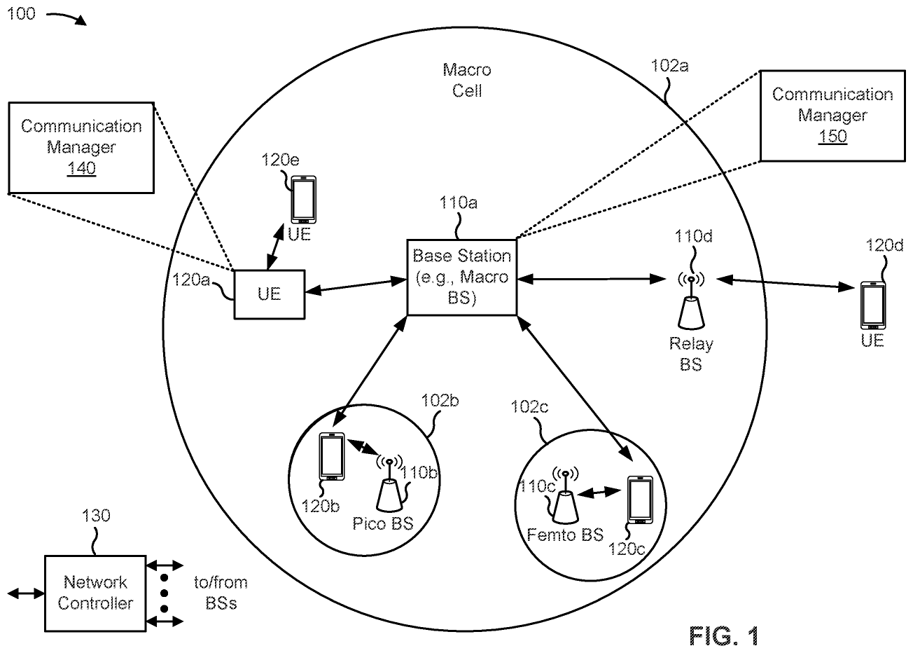

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may generate a measurement report for discovery that includes a serving relay UE source Layer 2 (L2) identifier (ID), of a serving relay UE that serves the remote UE, and a candidate relay UE source L2 ID, for each candidate relay UE of a set of candidate relay UEs. The communication manager 140 may transmit the measurement report.

In some aspects, a network entity (e.g., base station 110) may include a communication manager 150. As described in more detail elsewhere herein, the communication manager 150 may receive a measurement report for discovery that includes a serving relay UE source L2 ID, of a serving relay UE that serves a remote UE, and a candidate relay UE source L2 ID, for each candidate relay UE for the remote UE. The communication manager 150 may transmit a reconfiguration message to switch the remote UE from an indirect path to a direct path based at least in part on the serving relay UE source L2 ID in consideration of the candidate relay source L2 ID for each candidate relay UE.

In some aspects, the communication manager 140 may generate a message that includes a remote UE source L2 ID if the remote UE is in a connected state and transmit the message. Additionally, or alternatively, the communication manager 140 may perform one or more other operations described herein.

In some aspects, the communication manager 150 may receive, from a remote UE in a connected state, a sidelink UE information message that includes a remote UE source L2 ID for the remote UE. The communication manager 150 may receive, from a relay UE, a sidelink UE information message that includes the remote UE source L2 ID of the remote UE. The communication manager 150 may transmit, to the remote UE and the relay UE based at least in part on receiving the remote UE source L2 ID, a configuration message to switch the remote UE from a direct path to an indirect path via the relay UE. Additionally, or alternatively, the communication manager 150 may perform one or more other operations described herein.

As indicated above, FIG. 1 is provided as an example. Other examples may differ from what is described with regard to FIG. 1.

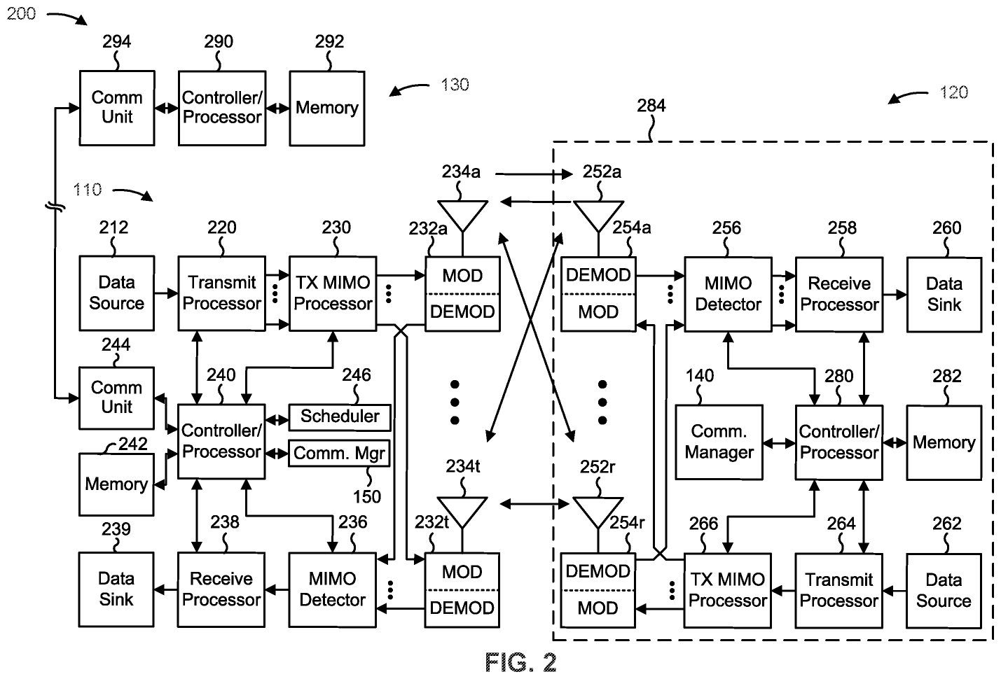

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

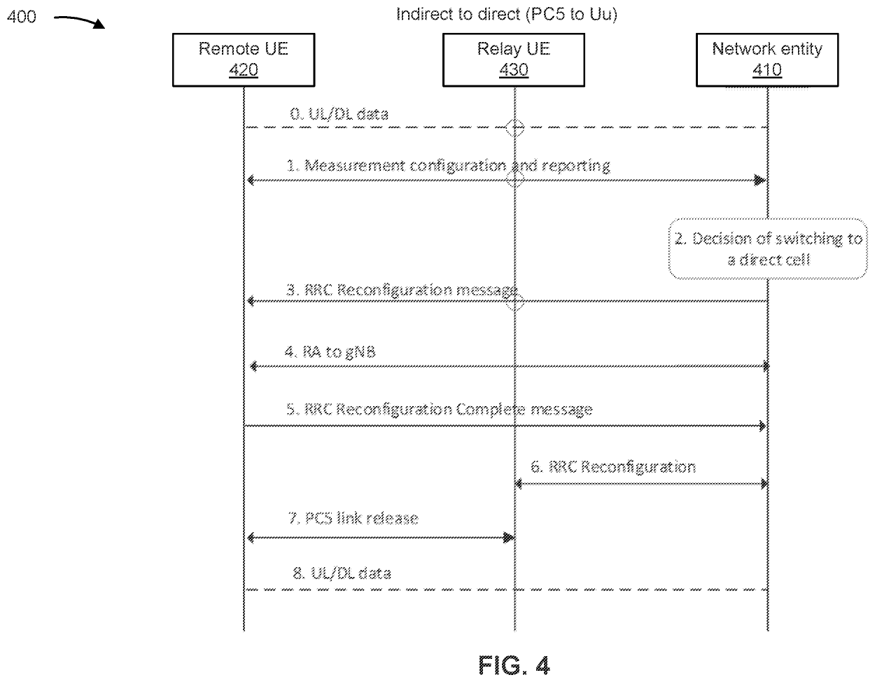

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., controller/processor 280) and the memory 282 to perform aspects of any of the methods described herein (e.g., with reference to FIGS. 4-13).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., controller/processor 240) and the memory 242 to perform aspects of any of the methods described herein (e.g., with reference to FIGS. 4-13).

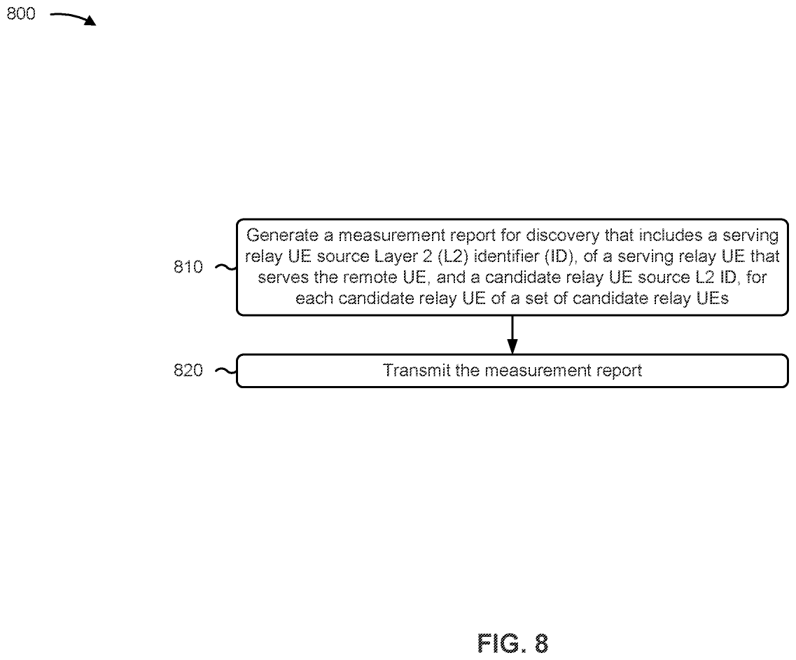

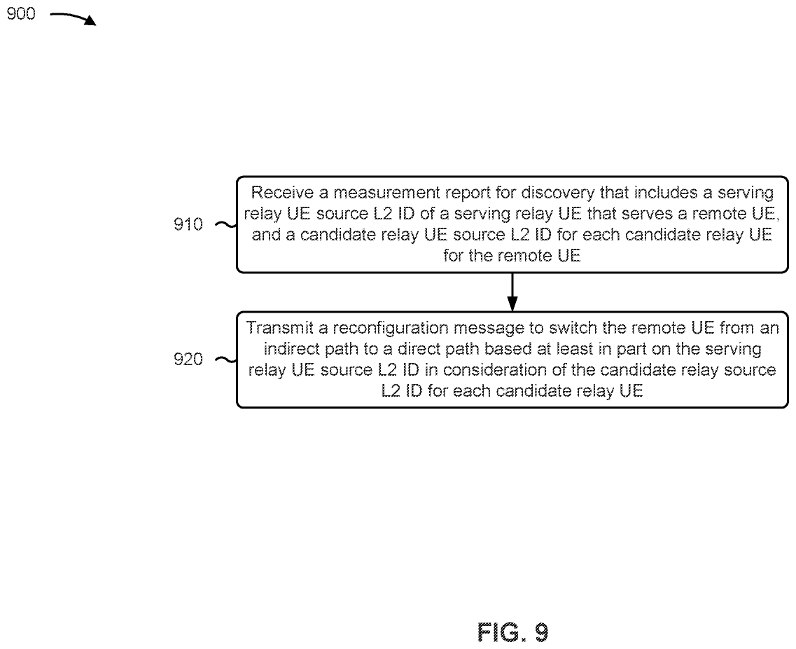

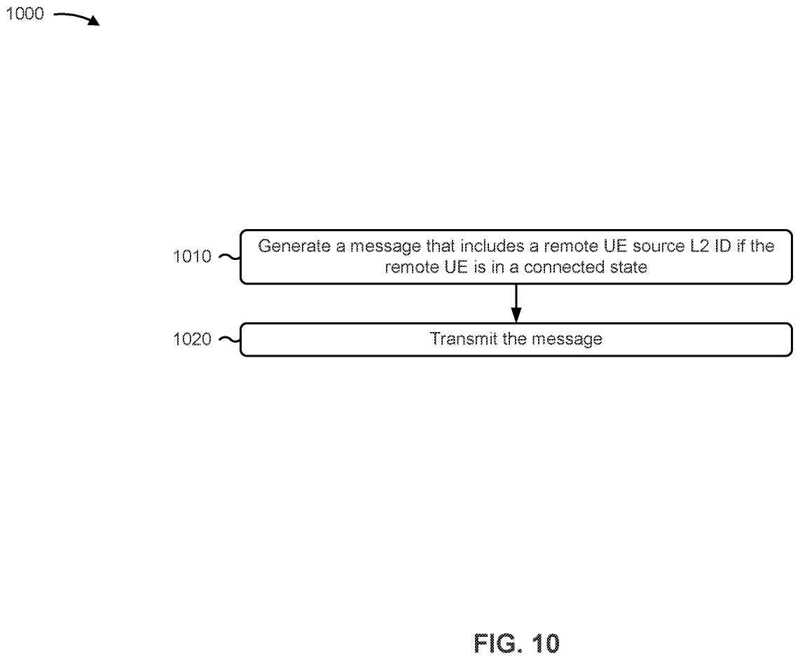

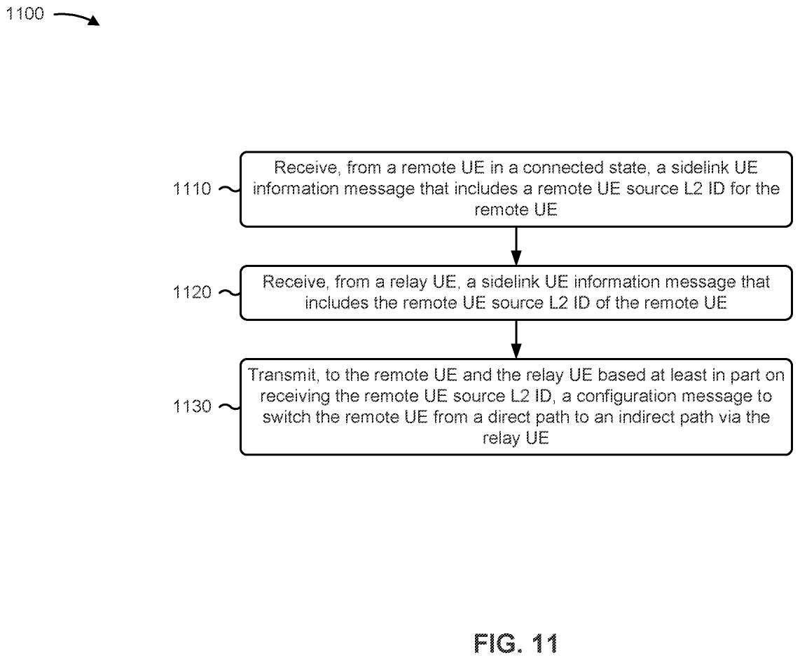

A controller/processor of a network entity, (e.g., controller/processor 240 of the base station 110), the controller/processor 280 of the UE 120, and/or any other component(s) of FIG. 2 may perform one or more techniques associated with providing source L2 IDs for path switching, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a remote UE (e.g., a UE 120) includes means for generating a measurement report for discovery that includes a serving relay UE source L2 ID of a serving relay UE that serves the remote UE, and a candidate relay UE source L2 ID, for each candidate relay UE of a set of candidate relay UEs; and/or means for transmitting the measurement report. The means for the remote UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for receiving a measurement report for discovery that includes a serving relay user UE source L2 ID, of a serving relay UE that serves a remote UE, and a candidate relay UE source L2 ID, for each candidate relay UE for the remote UE; and/or means for transmitting a reconfiguration message to switch the remote UE from an indirect path to a direct path based at least in part on the serving relay UE source L2 ID in consideration of the candidate relay source L2 ID for each candidate relay UE. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the remote UE includes means for generating a message that includes a remote UE source L2 ID if the remote UE is in a connected state; and/or means for transmitting the message.

In some aspects, the network entity includes means for receiving, from a remote UE in a connected state, a sidelink UE information message that includes a remote UE source L2 ID for the remote UE; means for receiving, from a relay UE, a sidelink UE information message that includes the remote UE source L2 ID of the remote UE; and/or means for transmitting, to the remote UE and the relay UE based at least in part on receiving the remote UE source L2 ID, a configuration message to switch the remote UE from a direct path to an indirect path via the relay UE.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

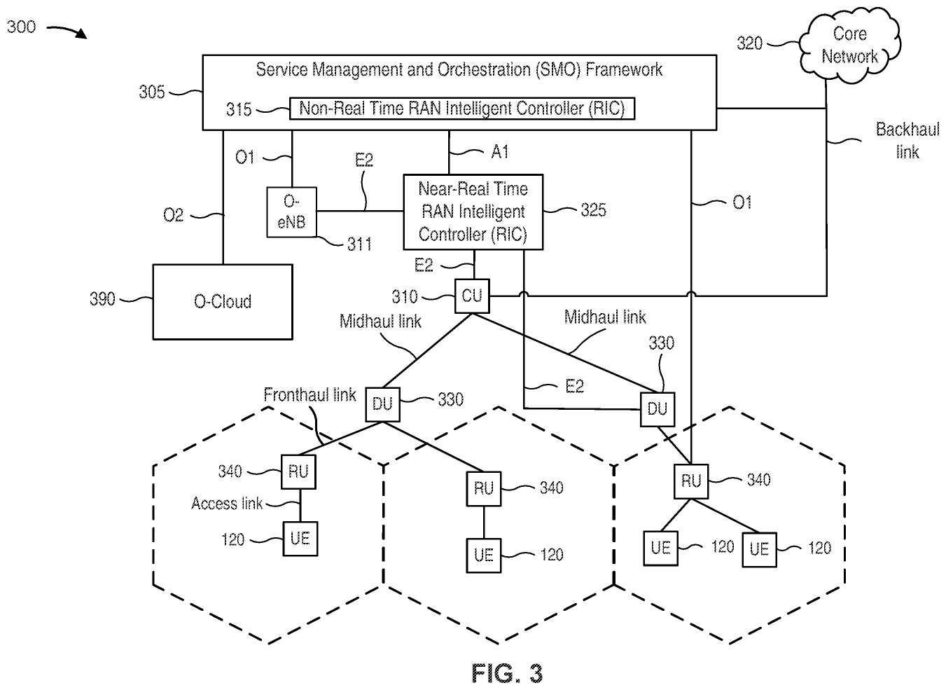

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more radio frequency (RF) access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (TRS), or other components that may provide a network interface for or serve a UE, mobile station, sensor/actuator, or other wireless device.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

FIG. 4 is a diagram illustrating an example 400 of switching from an indirect path to a direct path, in accordance with the present disclosure. Example 400 shows a network entity 410 (e.g., gNB), a remote UE 420, and a relay UE 430.

Example 400 shows the remote UE 420 in an indirect path to the network entity 410. The indirect path includes the relay UE 430, which relays communications between the remote UE 420 and the network entity 410. The remote UE 420 communicates with the relay UE 430 on a sidelink (PC5), and the relay UE communicates with the network entity 410 via an access link (Uu).

The remote UE 420 may switch from an indirect path to a direct path to the network entity 410 that does not include the relay UE 430. To switch paths, the remote UE 420 may transmit a measurement report to the network entity 410, and the network entity 410 may transmit an RRC reconfiguration message. The remote UE 420 may communicate with the network entity 410 on a Uu link and release the PC5 link. In some scenarios, the remote UE 420 may switch from one indirect path to another indirect path.

Path switching is a part of service continuity. Path switching may involve a remote UE transmitting measurement reports for candidate relay UEs (e.g., measurements of signals from the candidate UEs). The measurement reports may include UE IDs for the candidate relay UEs. For example, a remote UE is expected to include a serving relay UE ID and/or a candidate relay UE ID in the measurement report. The relay UE ID may be a relay UE's source L2 ID. If two UEs are communicating on a sidelink, one UE transmitting the data may be considered a source UE and the other UE may be considered a destination UE. Communications from the network entity may flow through a serving relay UE to the remote UE (on a sidelink between the relay UE and the remote UE), and the serving relay UE may then be considered a source UE.

Measurement reports may be for discovery. Model A discovery may include an announcing UE transmitting an announcement message (e.g., broadcast message) that is monitored for by monitoring UEs. Model B discovery may include a discoverer UE transmitting a solicitation message (e.g., broadcast message) to discoveree UEs that may transmit a response message. These messages may include L2 IDs. Remote UEs interested in an indirect path with a relay UE may discover the relay UE monitoring for relay service codes.

A relay UE in an RRC connected state may report its source L2 ID to the network entity via sidelink UE information (sidelinkUEInformationNR). The relay UE may also report an L2 ID to remote UEs. However, the relay UE may have multiple source L2 IDs and it has not been specified which source L2 ID the remote UE should report. If the relay UE has multiple PC5 links, the L2 ID can be different for each unicast link. Different L2 IDs may be used for discovery and sidelink communications. Without clarity as to the L2 IDs to include in the measurement report, a suboptimal path may be selected that provides suboptimal communications and causes the UEs to consume additional processing resources and signaling resources.

As indicated above, FIG. 4 is provided as an example. Other examples may differ from what is described with regard to FIG. 4.

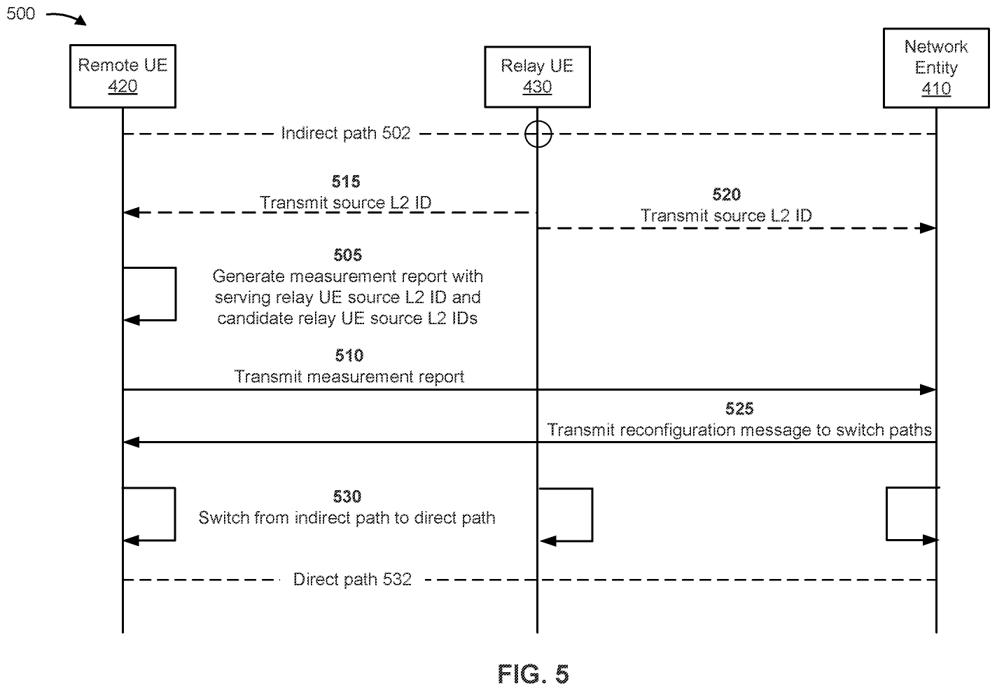

FIG. 5 is a diagram illustrating an example 500 associated with providing source L2 IDs for path switching, in accordance with the present disclosure. Example 500 shows a network entity 410 (e.g., gNB), a remote UE 420, and a relay UE 430. Example 500 shows the remote UE 420 using an indirect path 502 to the network entity 410 that includes the relay UE 430.

According to various aspects described herein, the remote UE 420 may include its serving relay UE's source L2 ID and any candidate relay UEs' source L2 ID for discovery in the measurement report to the network entity 410 (i.e., not the UE source L2 ID corresponding to the unicast PC5 link). Consequently, the source L2 ID for discovery does not change based on to which relay UE the remote UE 420 connects.

For example, as shown by reference number 505, the remote UE 420 may generate a measurement report for discovery that includes a serving relay UE source L2 ID of a serving relay UE (e.g., relay UE 430) that serves the remote UE, and a candidate relay UE source L2 ID for each candidate relay UE of a set of candidate relay UEs. As shown by reference number 510, the remote UE 420 may transmit the measurement report. The network entity 410 may use the measurement reports to switch a path of the remote UE 420 or otherwise connect or disconnect the remote UE 420 from the relay UE 430.

In some aspects, if a connected relay (e.g., relay UE 430) does not send a discovery message, the relay 430 may send its source L2 ID for discovery to the remote UE 420 via a PC5-RRC message. During PC5 link setup, the relay UE 430 may transmit its source L2 ID for discovery to remote UE 420, as shown by reference number 515. Once the relay UE 430's source L2 ID for discovery is updated, the relay 430 may transmit the updated L2 ID to the remote UE 420. As shown by reference number 520, a connected relay UE (e.g., relay UE 430 in an RRC connected state) may transmit its source L2 ID for discovery to the network entity 410 via a sidelink UE information message. A connected relay UE does not currently report its source L2 ID for discovery as part of a discovery procedure, and the network entity 410 does not currently consider a connected relay source L2 ID as part of a discovery procedure.

As shown by reference number 525, the network entity 410 may transmit an RRC reconfiguration message to instruct the remote UE 420 to switch from the indirect path 502 to the direct path 532. The network entity 410 may generate the reconfiguration message based at least in part on the measurement report. As shown by reference number 530, the remote UE 420 may switch to the direct path 532.

As indicated above, FIG. 5 is provided as an example. Other examples may differ from what is described with respect to FIG. 5.

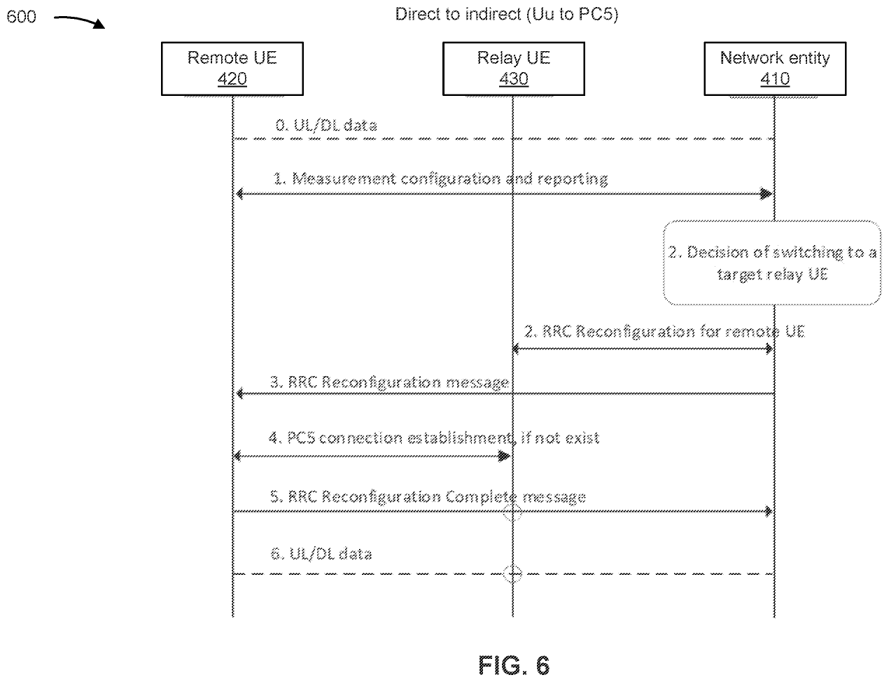

FIG. 6 is a diagram illustrating an example 600 of switching from a direct path to an indirect path, in accordance with the present disclosure.

Example 600 shows the remote UE 420 in a direct path to the network entity 410. The remote UE 420 may switch from the direct path to an indirect path to the network entity 410 that includes a relay UE. To switch paths, the remote UE 420 may transmit a measurement report to the network entity 410. The measurement report may include channel state information (CSI) or other signal measurements with respect to candidate relay UEs. The network entity 410 may transmit an RRC reconfiguration message indicating that the relay UE 430 will be the relay UE in the indirect path. The remote UE 420 may connect to and communicate with the relay UE 430 on a sidelink (PC5). The relay UE 430 may communicate with the network entity 410 on a Uu link, and the relay UE 430 may release the direct Uu link between the relay UE 430 and the network entity 410.

For switching from a direct path to an indirect path, the remote UE 420 in a direct connection with the network entity 410 has no active PC5 connection and may not send discovery messages. In this scenario, it has not been specified what L2 ID the remote UE 420 is to report to the network entity 410.

As indicated above, FIG. 6 is provided as an example. Other examples may differ from what is described with regard to FIG. 6.

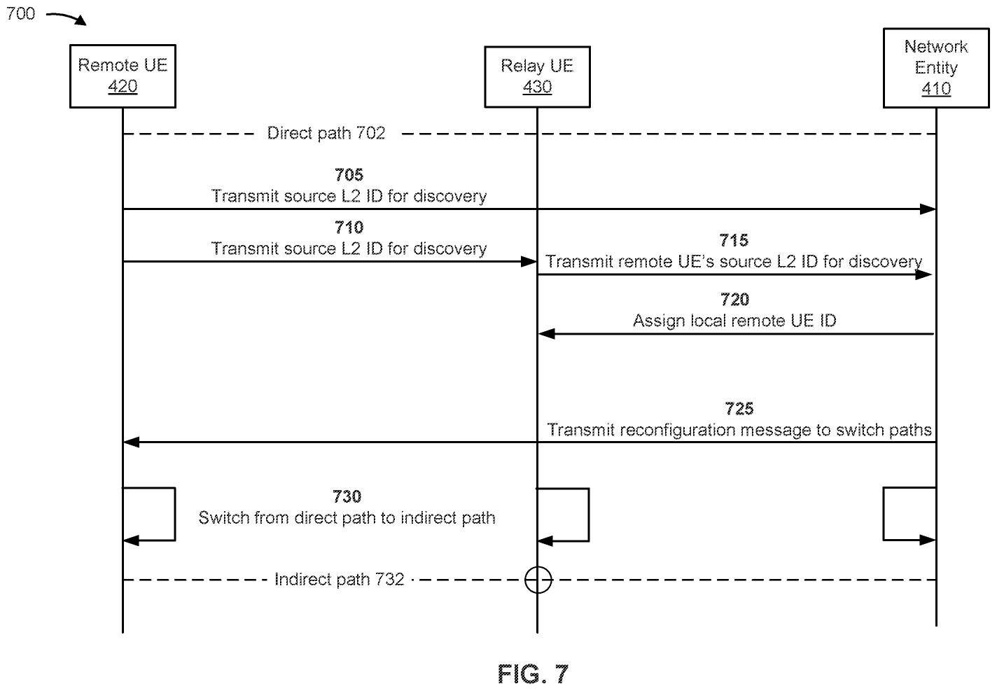

FIG. 7 is a diagram illustrating an example 700 associated with providing source L2 IDs for path switching, in accordance with the present disclosure. Example 700 shows the network entity 410 (e.g., gNB), the remote UE 420, and the relay UE 430. Example 700 shows the remote UE 420 using a direct path 702 to the network entity 410 that does not include the relay UE 430.

According to various aspects described herein, the remote UE 420 may be in a connected state and may include its source L2 ID for discovery in a sidelink UE information message (e.g., SidelinkUEInformationNR) to the network entity 410, as shown by reference number 705. Because the remote UE 420 is in a connected state, the remote UE 420 currently does not transmit a discovery message. As shown by reference number 710, the remote UE 420 may also transmit its source L2 ID for discovery to the relay UE 430 via a PC5-RRC message (e.g., during PC5 link setup). The relay UE 430 may use the source L2 ID to obtain a local UE ID of the remote UE 420. When the remote UE 420's source L2 ID for discovery is updated, the remote UE 420 may transmit the updated source L2 ID to the relay UE 430.

As shown by reference number 715, the relay UE 430 may transmit the remote UE's source L2 ID for discovery via a sidelink UE information message to the network entity 410. Afterward, the network entity 410 may determine and transmit the local remote UE ID to the relay UE 430, as shown by reference number 720. The local remote UE ID (shorter than source L2 ID) assignment may be used in an adaptation layer header. Shorter local remote UE IDs help with multi-hop communications.

By transmitting the remote UE source L2 ID for discovery purposes, the remote UE 420 and the relay UE 430 may provide the network entity 410 with more clarity for controlling path switch operations. As a result, the UEs have better communication paths and do not expend additional processing resources and signaling resources using suboptimal paths.

As shown by reference number 725, the network entity 410 may transmit an RRC reconfiguration message to instruct the remote UE 420 to switch from the direct path 702 to the indirect path 732. As shown by reference number 730, the remote UE 420 may switch to the indirect path 732.

As indicated above, FIG. 7 is provided as an example. Other examples may differ from what is described with respect to FIG. 7.

FIG. 8 is a diagram illustrating an example process 800 performed, for example, by a remote UE, in accordance with the present disclosure. Example process 800 is an example where the remote UE (e.g., UE 120, remote UE 420) performs operations associated with providing source L2 IDs for path switching.

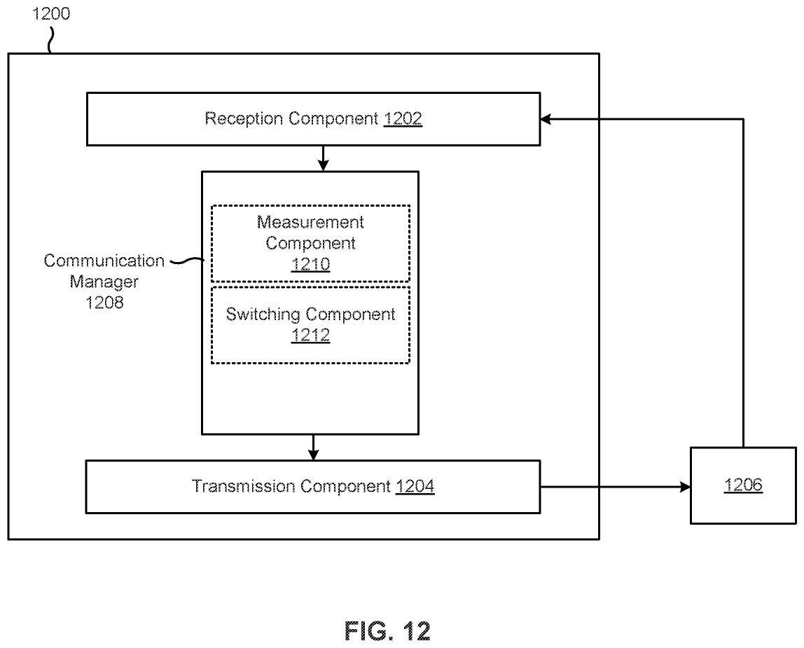

As shown in FIG. 8, in some aspects, process 800 may include generating a measurement report for discovery that includes a serving relay UE source L2 ID, of a serving relay UE that serves the remote UE, and a candidate relay UE source L2 ID, for each candidate relay UE of a set of candidate relay UEs (block 810). For example, the remote UE (e.g., using communication manager 1208 and/or measurement component 1210 depicted in FIG. 12) may generate a measurement report for discovery that includes a serving relay UE source L2 ID, of a serving relay UE that serves the remote UE, and a candidate relay UE source L2 ID, for each candidate relay UE of a set of candidate relay UEs, as described above.

As further shown in FIG. 8, in some aspects, process 800 may include transmitting the measurement report (block 820). For example, the remote UE (e.g., using communication manager 140 and/or transmission component 1204 depicted in FIG. 12) may transmit the measurement report, as described above.

Process 800 may include additional aspects, such as any single aspect or any combination of aspects described below and/or in connection with one or more other processes described elsewhere herein.

In a first aspect, process 800 includes switching from an indirect path that includes the serving relay UE to a direct path after receiving a reconfiguration message.

In a second aspect, alone or in combination with the first aspect, process 800 includes receiving a relay UE source L2 ID via a PC5 message if the remote UE does not receive a discovery message from a relay UE that is in a connected state.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., base station 110, network entity 410) performs operations associated with using source L2 IDs for path switching.

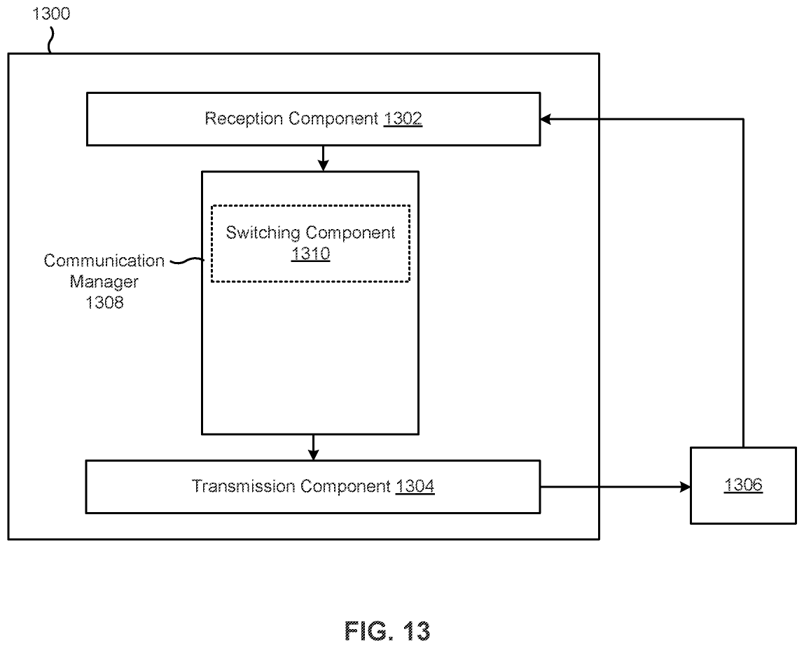

As shown in FIG. 9, in some aspects, process 900 may include receiving a measurement report for discovery that includes a serving relay UE source L2 ID, of a serving relay UE that serves a remote UE, and a candidate relay UE source L2 ID, for each candidate relay UE for the remote UE (block 910). For example, the network entity (e.g., using communication manager 1308 and/or reception component 1302 depicted in FIG. 13) may receive a measurement report for discovery that includes a serving relay UE source L2 ID, of a serving relay UE that serves a remote UE, and a candidate relay UE source L2 ID, for each candidate relay UE for the remote UE, as described above.

As further shown in FIG. 9, in some aspects, process 900 may include transmitting a reconfiguration message to switch the remote UE from an indirect path to a direct path based at least in part on the serving relay UE source L2 ID in consideration of the candidate relay source L2 ID for each candidate relay UE (block 920). For example, the network entity (e.g., using communication manager 1308 and/or transmission component 1304 depicted in FIG. 13) may transmit a reconfiguration message to switch the remote UE from an indirect path to a direct path based at least in part on the serving relay UE source L2 ID in consideration of the candidate relay source L2 ID for each candidate relay UE, as described above.

Process 900 may include additional aspects, such as any single aspect or any combination of aspects described below and/or in connection with one or more other processes described elsewhere herein.

In some aspects, process 900 includes receiving, via a sidelink UE information message, a relay UE source L2 ID for discovery from a relay UE that is in a connected state.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a remote UE, in accordance with the present disclosure. Example process 1000 is an example where the remote UE (e.g., UE 120, remote UE 420) performs operations associated with providing source L2 IDs for path switching.

As shown in FIG. 10, in some aspects, process 1000 may include generating a message that includes a remote UE source L2 ID if the remote UE is in a connected state (block 1010). For example, the remote UE (e.g., using communication manager 140 and/or measurement component 1210 depicted in FIG. 12) may generate a message that includes a remote UE source L2 ID if the remote UE is in a connected state, as described above.

As further shown in FIG. 10, in some aspects, process 1000 may include transmitting the message (block 1020). For example, the remote UE (e.g., using communication manager 140 and/or transmission component 1204 depicted in FIG. 12) may transmit the message, as described above.

Process 1000 may include additional aspects, such as any single aspect or any combination of aspects described below and/or in connection with one or more other processes described elsewhere herein.

In a first aspect, the message is a sidelink UE information message to a network entity.

In a second aspect, alone or in combination with the first aspect, the message is a PC5 message to a relay UE.

In a third aspect, alone or in combination with one or more of the first and second aspects, process 1000 includes switching, after receiving a reconfiguration message, from a direct path to a network entity to an indirect path to the network entity that includes a relay UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., base station 110, network entity 410) performs operations associated with using source L2 IDs for path switching.

As shown in FIG. 11, in some aspects, process 1100 may include receiving, from a remote UE in a connected state, a sidelink UE information message that includes a remote UE source L2 ID for the remote UE (block 1110). For example, the network entity (e.g., using communication manager 1308 and/or reception component 1302 depicted in FIG. 13) may receive, from a remote UE in a connected state, a sidelink UE information message that includes a remote UE source L2 ID for the remote UE, as described above.

As further shown in FIG. 11, in some aspects, process 1100 may include receiving, from a relay UE, a sidelink UE information message that includes the remote UE source L2 ID of the remote UE (block 1120). For example, the network entity (e.g., using communication manager 1308 and/or reception component 1302 depicted in FIG. 13) may receive, from a relay UE, a sidelink UE information message that includes the remote UE source L2 ID of the remote UE, as described above.

As further shown in FIG. 11, in some aspects, process 1100 may include transmitting, to the remote UE and the relay UE based at least in part on receiving the remote UE source L2 ID, a configuration message to switch the remote UE from a direct path to an indirect path via the relay UE (block 1130). For example, the network entity (e.g., using communication manager 1308 and/or transmission component 1304 depicted in FIG. 13) may transmit, to the remote UE and the relay UE based at least in part on receiving the remote UE source L2 ID, a configuration message to switch the remote UE from a direct path to an indirect path via the relay UE, as described above.

Process 1100 may include additional aspects, such as any single aspect or any combination of aspects described below and/or in connection with one or more other processes described elsewhere herein.

In a first aspect, process 1100 includes communicating with the remote UE via the relay UE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE (e.g., a UE 120, remote UE 420), or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 1208 may control and/or otherwise manage one or more operations of the reception component 1202 and/or the transmission component 1204. In some aspects, the communication manager 1208 may include one or more antennas, a modem, a controller/processor, a memory, or a combination thereof, of the UE described in connection with FIG. 2. The communication manager 1208 may be, or be similar to, the communication manager 140 depicted in FIGS. 1 and 2. For example, in some aspects, the communication manager 1208 may be configured to perform one or more of the functions described as being performed by the communication manager 150. In some aspects, the communication manager 1208 may include the reception component 1202 and/or the transmission component 1204. The communication manager 1208 may include a measurement component 1210 and/or a switching component 1212, among other examples.

In some aspects, the apparatus 1200 may be configured to perform one or more operations described herein in connection with FIGS. 1-7. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

In some aspects, in relation to switching from an indirect path to a direct path, the measurement component 1210 may generate a measurement report for discovery that includes a serving relay UE source L2 ID of a serving relay UE that serves the remote UE and a candidate relay UE source L2 ID, for each candidate relay UE of a set of candidate relay UEs. The transmission component 1204 may transmit the measurement report.

The switching component 1212 may switch from an indirect path that includes the serving relay UE to a direct path after receiving a reconfiguration message.

The reception component 1202 may receive a relay UE source L2 ID via a PC5 message if the remote UE does not receive a discovery message from a relay UE that is in a connected state.

In some aspects, in relation to switching from a direct path to an indirect path, the measurement component 1210 may generate a message that includes a remote UE source L2 ID if the remote UE is in a connected state. The transmission component 1204 may transmit the message.

The switching component 1212 may switch, after receiving a reconfiguration message, from a direct path to a network entity to an indirect path to the network entity that includes a relay UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network entity (e.g., a base station 110, network entity 410), or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 1308. The communication manager 1308 may control and/or otherwise manage one or more operations of the reception component 1302 and/or the transmission component 1304. In some aspects, the communication manager 1308 may include one or more antennas, a modem, a controller/processor, a memory, or a combination thereof, of the base station described in connection with FIG. 2. The communication manager 1308 may be, or be similar to, the communication manager 150 depicted in FIGS. 1 and 2. For example, in some aspects, the communication manager 1308 may be configured to perform one or more of the functions described as being performed by the communication manager 150. In some aspects, the communication manager 1308 may include the reception component 1302 and/or the transmission component 1304. The communication manager 1308 may include a switching component 1310, among other examples.

In some aspects, the apparatus 1300 may be configured to perform one or more operations described herein in connection with FIGS. 1-7. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the network entity described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network entity described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network entity described in connection with FIG. 2. In some aspects, the transmission component 1304 may be co-located with the reception component 1302 in a transceiver.

In some aspects, in relation to switching from an indirect path to a direct path, the reception component 1302 may receive a measurement report for discovery that includes a serving relay UE source L2 ID, of a serving relay UE that serves a remote UE, and a candidate relay UE source L2 ID, for each candidate relay UE for the remote UE. The switching component may generate a reconfiguration message to switch paths based at least in part on the measurement report and the source L2 IDs in the measurement report. The transmission component 1304 may transmit the reconfiguration message to switch the remote UE from an indirect path to a direct path based at least in part on the serving relay UE source L2 ID in consideration of the candidate relay source L2 ID for each candidate relay UE.

The reception component 1302 may receive, via a sidelink UE information message, a relay UE source L2 ID for discovery from a relay UE that is in a connected state.

The reception component 1302 may receive, from a remote UE in a connected state, a sidelink UE information message that includes a remote UE source L2 ID for the remote UE. The reception component 1302 may receive, from a relay UE, a sidelink UE information message that includes the remote UE source L2 ID of the remote UE. The transmission component 1304 may transmit, to the remote UE and the relay UE based at least in part on receiving the remote UE source L2 ID, a configuration message to switch the remote UE from a direct path to an indirect path via the relay UE.

The transmission component 1304 and the reception component 1302 may communicate with the remote UE via the relay UE.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a remote user equipment (UE), comprising: generating a measurement report for discovery that includes a serving relay UE source Layer 2 (L2) identifier (ID), of a serving relay UE that serves the remote UE, and a candidate relay UE source L2 ID, for each candidate relay UE of a set of candidate relay UEs; and transmitting the measurement report.

Aspect 2: The method of Aspect 1, further comprising switching from an indirect path that includes the serving relay UE to a direct path after receiving a reconfiguration message.

Aspect 3: The method of Aspect 1 or 2, further comprising receiving a relay UE source L2 ID via a PC5 message if the remote UE does not receive a discovery message from a relay UE that is in a connected state.

Aspect 4: A method of wireless communication performed by a network entity, comprising: receiving a measurement report for discovery that includes a serving relay user equipment (UE) source Layer 2 (L2) identifier (ID), of a serving relay UE that serves a remote UE, and a candidate relay UE source L2 ID, for each candidate relay UE for the remote UE; and transmitting a reconfiguration message to switch the remote UE from an indirect path to a direct path based at least in part on the serving relay UE source L2 ID in consideration of the candidate relay source L2 ID for each candidate relay UE.

Aspect 5: The method of Aspect 4, further comprising receiving, via a sidelink UE information message, a relay UE source L2 ID for discovery from a relay UE that is in a connected state.

Aspect 6: A method of wireless communication performed by a remote user equipment (UE), comprising: generating a message that includes a remote UE source Layer 2 (L2) identifier (ID) if the remote UE is in a connected state; and transmitting the message.

Aspect 7: The method of Aspect 6, wherein the message is a sidelink UE information message to a network entity.

Aspect 8: The method of Aspect 6, wherein the message is a PC5 message to a relay UE.

Aspect 9: The method of any of Aspects 6-8, further comprising switching, after receiving a reconfiguration message, from a direct path to a network entity to an indirect path to the network entity that includes a relay UE.

Aspect 10: A method of wireless communication performed by a network entity, comprising: receiving, from a remote user equipment (UE) in a connected state, a sidelink UE information message that includes a remote UE source Layer 2 (L2) identifier (ID) for the remote UE; receiving, from a relay UE, a sidelink UE information message that includes the remote UE source L2 ID of the remote UE; and transmitting, to the remote UE and the relay UE based at least in part on receiving the remote UE source L2 ID, a configuration message to switch the remote UE from a direct path to an indirect path via the relay UE.

Aspect 11: The method of Aspect 10, further comprising communicating with the remote UE via the relay UE.

Aspect 12: An apparatus for wireless communication at a device, comprising a processor; memory coupled with the processor; and instructions stored in the memory and executable by the processor to cause the apparatus to perform the method of one or more of Aspects 1-11.

Aspect 13: A device for wireless communication, comprising a memory and one or more processors coupled to the memory, the one or more processors configured to perform the method of one or more of Aspects 1-11.

Aspect 14: An apparatus for wireless communication, comprising at least one means for performing the method of one or more of Aspects 1-11.

Aspect 15: A non-transitory computer-readable medium storing code for wireless communication, the code comprising instructions executable by a processor to perform the method of one or more of Aspects 1-11.

Aspect 16: A non-transitory computer-readable medium storing a set of instructions for wireless communication, the set of instructions comprising one or more instructions that, when executed by one or more processors of a device, cause the device to perform the method of one or more of Aspects 1-11.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1.-11. (canceled)

12. A remote user equipment (UE) for wireless communication, comprising:
a memory; and
one or more processors, coupled to the memory, configured to:
generate a measurement report for discovery that includes a serving relay UE source Layer 2 (L2) identifier (ID), of a serving relay UE that serves the remote UE, and a candidate relay UE source L2 ID, for each candidate relay UE of a set of candidate relay UEs; and
transmit the measurement report.

13. The remote UT of claim 12, wherein the one or more processors are configured to switch from an indirect path that includes the serving relay UE to a direct path after receiving a reconfiguration message.

14. The remote UE of claim 12, wherein the one or more processors are configured to receive a relay UE source L2 ID via a PC5 message if the remote UE does not receive a discovery message from a relay UE that is in a connected state.

15. A network entity for wireless communication, comprising:
a memory, and
one or more processors, coupled to the memory, configured to:
receive a measurement report for discovery that includes a serving relay user equipment (UE) source Layer 2 (L2) identifier (ID), of a serving relay UE that serves a remote UE, and a candidate relay UE source L2 ID, for each candidate relay UE for the remote UE; and
transmit a reconfiguration message to switch the remote UE from an indirect path to a direct path based at least in part on the serving relay UE source L2 ID in consideration of the candidate relay source L2 ID for each candidate relay UE.

16. The network entity of claim 15, wherein the one or more processors are configured to receive, via a sidelink UE information message, a relay UE source L2 ID for discovery from a relay UE that is in a connected state.

17. A remote user equipment (TE) for wireless communication, comprising:
a memory; and
one or more processors, coupled to the memory, configured to:
generate a message that includes a remote UE source Layer 2 (L2) identifier (ID) if the remote UE is in a connected state; and
transmit the message.

18. The remote UE of claim 17, wherein the message is a sidelink UE information message to a network entity.

19. The remote UE of claim 17, wherein the message is a PC5 message to a relay UE.

20. The remote UE of claim 17, wherein the one or more processors are configured to switch, after receiving a reconfiguration message, from a direct path to a network entity to an indirect path to the network entity that includes a relay UE.

21. A network entity for wireless communication, comprising:
a memory; and
one or more processors, coupled to the memory, configured to:
receive, from a remote user equipment (UE) in a connected state, a sidelink UT information message that includes a remote UE source Layer 2 (L2) identifier (ID) for the remote UE;
receive, from a relay UT, a sidelink TE information message that includes the remote UE source L2 ID of the remote UE; and
transmit, to the remote UE and the relay UE based at least in part on receiving the remote UE source L2 ID, a configuration message to switch the remote UE from a direct path to an indirect path via the relay UE.

22. The network entity of claim 21, wherein the one or more processors are configured to communicate with the remote UE via the relay UE.

23.-44. (canceled)
